(19) United States
(12) Patent Application Publication
(10) Pub. No.: US 2025/0368851 A1
(43) Pub. Date: Dec. 4, 2025

(54) TWO-COMPONENT COATING COMPOSITION AND COATING SYSTEM

(71) Applicant: PPG COATINGS (TIANJIN) CO., LTD., Tianjin (CN)

(72) Inventors: Hairong Huang, Tianjin (CN); Qun Niu, Tianjin (CN); Nan LV, Tianjin (CN); Hongwang Zhao, Tianjin (CN); Qingzhu Du, Tianjin (CN)

(73) Assignee: PPG COATINGS (TIANJIN) CO., LTD., Tianjin (CN)

(21) Appl. No.: 18/869,014

(22) PCT Filed: May 26, 2023
(86) PCT No.: PCT/CN2023/096499

§ 371 Date: Nov. 25, 2024

(30) Foreign Application Priority Data
May 27, 2022 (CN) 202210592755.X

(51) Int. Cl. C09D 175/04; C08G 18/62; C08J 7/04; C09D 7/20

(52) U.S. Cl. CPC C09D 175/04; C08G 18/6229; C08J 7/042; C09D 7/20; C08J 2369/00; C08J 2475/04

(57) ABSTRACT

Disclosed is a two-component (2K) coating composition comprising a first component and a second component, wherein the first component comprises a hydroxyl acrylic resin and an organic solvent. and the second component comprises an isocyanate curing agent, wherein the hydroxyl acrylic resin has a number average molecular weight of 10,000 to 30,000, the hydroxyl acrylic resin comprises an acrylic resin with a low hydroxyl value and an acrylic resin with a medium hydroxyl value, the acrylic resin with a low hydroxyl value has a hydroxyl value of less than 30 mg KOH/g, the acrylic resin with a medium hydroxyl value has a hydroxyl value of 30 to 70 mg KOH/g. Also disclosed is a coated substrate comprising a substrate and the 2K coating composition coated onto at least a part of the substrate. Further disclosed is a coating system comprising a first coating composition and a second coating composition, wherein the first coating composition and/or the second coating composition are the 2K coating composition. The present invention further provides a unit and a plurality of methods for treating the unit.

### INVENTION FIELD

The present invention relates to the field of coatings, in particular to a two-component (2K) coating composition and a coating system.

### BACKGROUND

Recently, new energy vehicles have developed rapidly, and light-emitting parts such as light-emitting grilles and decorative strips (trims) are increasingly favored by the market, which are widely used in new energy vehicles. Light-emitting parts of vehicles not only help to improve the first impression, visual effect and recognition of the vehicles, but also remind the front and rear vehicles when driving during the daytime and at night. Coatings applied onto the light-emitting parts can both adjust appearance effects such as the color of external visual light sources and light transmittance, and cooperate with processes to design a plurality of styles, thereby playing an important role. At present, there are almost no such coatings on the market. With the development of new energy vehicles, such coatings will necessarily have a great market potential.

The substrates of light-emitting grilles, trims or similar parts are different from the shading substrates of conventional parts of vehicles, as these light-emitting parts are usually transparent or translucent plastic substrates, so that the coatings are required to have a stronger hiding power. Moreover, due to the poor weather resistance or the poor solvent resistance of the transparent or translucent substrates, the coatings are required to have a stronger weather resistance and an appropriate solvent resistance of substrates. In addition, in the coating technology, the coatings for light-emitting parts should both meet customers' requirements for the effect of light transmission, and for the color requirements. Moreover, as these substrates are different from the conventional substrates, they should also ensure the requirements of coating mechanical performances. In addition, during the application of such coatings, a laser etching technology is often used to meet the requirements of different styles.

Therefore, in order to meet the market demand and the business growth, there is a need to develop high-performance coatings and coating systems which have simultaneously good performances, various colors and light transmittance to be suitable for transparent or translucent plastic substrates.

### SUMMARY OF THE INVENTION

The inventor has done a lot of research and developed a coating composition suitable for transparent or translucent plastic substrates which has excellent hiding power (e.g., suitable to function as an opaque coating composition), weather resistance and solvent resistance; and a coating system suitable for transparent or translucent plastic substrates which meets the requirements of light transmission effect, color effect and mechanical properties, and thus can be advantageously used to apply on light-emitting parts.

The present invention provides a 2K coating composition comprising a first component and a second component, wherein the first component comprises a hydroxyl acrylic resin and an organic solvent, and the second component comprises an isocyanate curing agent, wherein the hydroxyl acrylic resin has a number average molecular weight of 10,000 to 30,000, the hydroxyl acrylic resin comprises an acrylic resin with a low hydroxyl value and an acrylic resin with a medium hydroxyl value, wherein the acrylic resin with a low hydroxyl value has a hydroxyl value of less than 30 mg KOH/g, and the acrylic resin with a medium hydroxyl value has a hydroxyl value of 30 to 70 mg KOH/g.

The present invention further provides a coated substrate comprising a substrate and the 2K coating composition coated on at least a part of the substrate.

The present invention further provides a coating system comprising a first coating composition and a second coating composition, wherein the first coating composition and/or the second coating composition are a 2K coating composition comprising a first component and a second component, wherein the first component comprises an hydroxyl acrylic resin and an organic solvent, the second component comprises an isocyanate curing agent, wherein the hydroxyl acrylic resin has a number average molecular weight of 10,000 to 30,000, the hydroxyl acrylic resin comprises an acrylic resin with a low hydroxyl value and an acrylic resin with a medium hydroxyl value, the acrylic resin with a low hydroxyl value has a hydroxyl value of less than 30 mg KOH/g, and the acrylic resin with a medium hydroxyl value has a hydroxyl value of 30 to 70 mg KOH/g.

The present invention additionally provides a unit comprising an inner surface and an outer surface, wherein the inner surface is at least partially coated with a transparent primer, an opaque basecoat and a translucent topcoat, and the outer surface is at least partially coated with a transparent topcoat.

The present invention additionally provides a first method of treating a unit comprising: applying a transparent primer, an opaque basecoat and a translucent topcoat in sequence on at least a part of an inner surface of the unit; and applying a transparent topcoat on at least a part of an outer surface of the unit.

The present invention additionally provides a second method of treating a unit comprising: applying a transparent primer, an opaque basecoat, a translucent basecoat and a transparent topcoat in sequence on at least a part of an outer surface of the unit.

The present invention additionally provides a third method of treating a unit comprising: applying a transparent primer and an opaque basecoat in sequence on at least a part of an inner surface of the unit; and applying a transparent primer, a translucent basecoat and a transparent topcoat in sequence on at least a part of an outer surface of the unit.

The features and advantage of the present invention are presented in particular from the following detailed description.

### BRIEF DESCRIPTION OF DRAWINGS

FIG. 1 shows a schematic view (a) and an illumination effect picture (b) of a unit obtained in accordance with the first treating method of the present invention.

FIG. 2 shows an effect picture and an illumination effect picture of a unit obtained in accordance with the second treating method of the present invention: (a) after applying the opaque basecoat on at least a part of the outer surface of the unit, treating part of the outer surface of the unit with laser etching; and (b) after applying the transparent topcoat on at least a part of the outer surface of the unit, treating part of the outer surface of the unit with laser etching.

### DETAILED DESCRIPTION OF THE INVENTION

In the present application, unless otherwise clearly indicated, the use of a singular comprises a plural and the use of a plural comprises a singular. For example, even though “a” resin is mentioned herein, one or more resins can be used.

In the present application, the terms “comprise (comprising, comprised)”, “contain (containing, contained)”, “include (including, included)” etc. are not intended to limit the present invention to exclude any variation or addition. Moreover, even though the present invention has utilized “comprise (comprising, comprised)” or similar terms to describe the coating composition, the preparation method, etc., the coating composition, the preparation method, and the like as detailed herein can also be described as “consisting essentially of” or “consisting of′. In this case, “consisting essentially of” means that any additional ingredient would not affect substantively the properties of the coating layer formed by the coating composition.

In the present application, unless otherwise clearly indicated, the use of “or” represents “and/or”, even if “and/or” can be clearly used in some cases. In addition, any numerical range listed herein is intended to encompass all the subranges included thereof. For example, a range of “1 to 10” is intended to encompass all the subranges between the listed minimum value of 1 and the listed maximum value of 10 (inclusive), that is, all the subranges having a minimum value equal to or greater than 1 and a maximum value equal to or less than 10.

Unless described in the examples or otherwise clearly stated, it should be understood that all the numerical values representing the quantities of ingredients or the like as used in the description and claims can vary in all cases according to the term “about”. Therefore, unless indicated to the contrary, the numerical parameters listed in the following description and claims are approximations and can vary according to the desired properties of the present invention. At least, not to limit the application of the doctrine of equivalence to the scope of claims, each numerical parameter should at least be interpreted according to significant figures and ordinary rounding should be applied.

Although the numerical ranges and parameters representing the broad scope of the invention are approximations, the numerical records listed in the specific examples are as accurate as possible. However, any numerical value inherently has a certain error, which is an inevitable result of the standard deviation obtained in its corresponding measurement method.

In an aspect, the present invention relates to a 2K coating composition comprising a first component and a second component, wherein the first component comprises a hydroxyl acrylic resin and an organic solvent, and the second component comprises an isocyanate curing agent.

Herein, the “two-component (2K) coating”, also known as two-package coating or two-pot coating, refers to a coating material comprising two components which are separately packaged, and then mixed at an accurate ratio immediately before use to form a film by curing.

The coating composition according to the present invention is a solvent-borne coating composition. By “solvent-borne” is meant that organic solvent is used as the main dispersing medium in the coating material. Herein, the organic solvent comprises at least 50 wt. % of the total weight of the dispersing medium.

The coating composition according to the present invention is a thermoset coating composition, i.e., after curing, the coating composition forms irreversibly a coating film that cannot be molten by re-heating and is insoluble in a solvent. Herein, the term “curing” means that at least a portion of the ingredients in the coating composition is polymerized and/or crosslinked, or dried to form a hardened coating film. The coating composition according to the present invention can be cured by heating.

The coating composition according to the present invention is a low-temperature curing system. Suitably, the coating composition according to the present invention is curable at 60 to 100° C. within 30 to 60 min. The “curable” means that after baking at 60-100° C. for 30-60 min, the formed film layer has an MEK double wiping value of at least 50, suitably even at least 70.

The coating composition according to the present invention can be used as a primer, a basecoat, and/or a topcoat. Herein, the “primer” refers to a coating layer directly applied onto a treated/untreated substrate which can provide protection and improve adhesion to basecoat and substrate. Herein, the “basecoat” refers to a coating layer applied on a primer which commonly comprises a pigment to provide color and/or effect, and/or adjust light transmittance. In the text, the “topcoat” refers to a coating layer applied on a basecoat which can be the outermost layer on the substrate, and can also comprises a pigment to provide different colors and/or light transmittances.

The coating composition according to the present invention can be formed to a transparent coating, a translucent (semi-transparent) coating, and/or an opaque (shading) coating. The “transparent”, including substantially transparent or fully transparent coatings, means that when viewed through the coating, the surface on the opposite side of the coating is clearly visible to naked eyes. Suitably, the transparent coating may have a light transmittance of at least 90%. The term “opaque (shading)” means that when viewed through the coating, the surface on the opposite side of the coating is invisible to naked eye. Suitably, the opaque/shading coating may have a light transmittance of less than 2%. The “translucent” is a coating in a state between transparent and opaque/shading. Suitably, the translucent coating may have a light transmittance of at least 2% and less than 90%. The light transmittance can be obtained by a BYK cloud meter BYK haze-gard I in accordance with ISO13468 standard.

The coating composition according to the present invention may have a solid content of 20 to 50 wt. %, suitably a solid content of 30 to 40 wt. %. In the text, the term “solid content” refers to a ratio of the residual mass of a coating composition after curing by drying to the mass of the coating composition prior to curing by drying.

The coating composition according to the present invention may form a micron-size coating, i.e., a coating having a dry film thickness in the micrometer range. Suitably, the coating layer formed from the coating composition according to the present invention may have a dry film thickness of 10 to 40 μm.

The hydroxyl acrylic resin contained in the first component refers to an acrylic resin containing hydroxyl functional group. Herein, the acrylic resin refers to a homopolymer of acrylates or methacrylates, and or a copolymer of acrylates or methacrylates with other monomers.

Suitably, the hydroxyl acrylic resin may have a number average molecular weight (Mn) of at least 10,000, e.g., a Mn of 10,000 to 30,000 Mn, such as, 20,000 to 30,000. Unless stated otherwise, molecular weights are given herein in g/mol. The number average molecular weight may be measured by gel permeation chromatography using an appropriate standard such as polystyrene standard. Suitably, the hydroxyl acrylic resin has an acid value of not greater than 15 mg KOH/g, such as, an acid value of not greater than 10 mg KOH/g, e.g., an acid value of not greater than 8 mg KOH/g, e.g., an acid value of not greater than 2 mg KOH/g. The “acid value” refers to a number of milligrams of potassium hydroxide required to neutralize the free acid in one gram of resin.

The hydroxyl acrylic resin may comprise an acrylic resin with a low hydroxyl value and an acrylic resin with a medium hydroxyl value. The acrylic resin with a low hydroxyl value may have a hydroxyl value of less than 30 mg KOH/g, suitably a hydroxyl value of less than 25 mg KOH/g, such as, a hydroxyl value of 10 to 25 mg KOH/g. The acrylic resin with a medium hydroxyl value may have a hydroxyl value of 30 to 70 mg KOH/g, suitably a hydroxyl value of 30 to 60 mg KOH/g, such as, a hydroxyl value of 35 to 50 mg KOH/g. Suitably, the weight ratio of the acrylic resin with a low hydroxyl value to the acrylic resin with a medium hydroxyl value is 1.5 to 3:1.

Suitably, the hydroxyl acrylic resin may have a glass transmission temperature (Tg) of not greater than 80° C., such as, a Tg of 10 to 60° C. The Tg can be measured by dynamic thermomechincal analysis (DMA) using a TA Instruments Q800 instrument with measurement parameters of: a frequence of 10 Hz, an amplitude of 5 mm, a temperature ramp of −100° C. to 250° C.; the Tg is determined as a peak of tan δ curve in accordance with ASTM D7028 (2022).

In general, the hydroxyl acrylic resin may be added in a form of solution into the coating composition. The solution can have a solid content of 45-65 wt %. The “solid content” refers to a percentage of the residual mass of the solution after evaporation in the mass of the original solution.

Based on the total weight of the first component, the hydroxyl acrylic resin may be at least about 4 wt. %, suitably at least about 7 wt. %, suitably at least about 10 wt. %, and/or at most about 40 wt. %, such as, at most about 30 wt. %, suitably at most about 25 wt. %. Based on the total weight of the first component, the hydroxyl acrylic resin may be about 4-40 wt. %, suitably 7-30 wt. %, such as, 10-25 wt. %, or within a range of any other combinations of these end values.

The organic solvent contained in first component is the main dispersing medium in the first component. Suitably, the organic solvent comprises an ester solvent, a ketone solvent, an alkane solvent and an alcohol solvent. The ester solvent may be one or more selected from the group consisting of ethyl acetate, butyl acetate, isobutyl acetate, amyl acetate, butyl propionate, ethylene glycol butyl ether acetate, and propylene glycol methyl ether acetate. The ketone solvent may be one or more selected from the group consisting of methyl isobutyl ketone, diacetone alcohol, diisobutyl ketone, and methyl n-pentyl ketone. The alkane solvent may be one or more selected from the group consisting of cyclohexane, n-hexane, n-heptane, and Solvent Oil 100 (trimethylbenzene). The alcohol solvent may be one or more selected from the group consisting of isopropanol, n-propanol, isobutanol, and n-butanol.

Based on the total weight of the first component, the organic solvent may comprise 15 to 40 wt. % of an ester solvent, 3 to 10 wt. % of a ketone solvent, 3 to 10 wt. % of an alkane solvent and 0.5 to 5 wt. % of an alcohol solvent.

The first component may further comprise a non-hydroxyl acrylic resin. The non-hydroxyl acrylic resin may be free of hydroxyl group. The non-hydroxyl acrylic resin may comprise a carbamate linkage.

Suitably, the non-hydroxyl acrylic resin has a number average molecular weight (Mn) of at least 40,000, e.g., a Mn of 40,000-50,000. The number average molecular weight may be measured by gel permeation using an appropriate standard such as polystyrene standard. Suitably, the non-hydroxyl acrylic resin has a Tg of not greater than 120° C., such as, a Tg of 50 to 100° C. The Tg may be measured by dynamic thermodynamic analysis (DMA) using TA Instruments Q800 instrument with measurement parameters of: a frequency of 10 Hz, an amplitude of 5 mm, a temperature ramp of −100° C. to 250° C.; the Tg is determined as a peak of tan δ curve in accordance with ASTM D7028 (2022).

In general, the non-hydroxylacrylic resin may be added in a form of solution into the coating composition. The solution may have a solid content of 25-30 wt. %. The “solid content” refers to a percentage of the residual mass of the solution after evaporation in the mass of the original solution.

Based on the total weight of the first component, the non-hydroxylacrylic resin may be at least about 0 wt. %, suitably at least about 2 wt. %, and/or at most about 10 wt. %, such as, at most about 6 wt. %. Based on the total weight of the first component, the non-hydroxylacrylic resin may be about 0-10 wt. %, suitably 2-6 wt. %, or within a range of any other combinations of these end values.

In the coating composition according to the present invention, the weight ratio of the hydroxyl acrylic resin to the non-hydroxyl acrylic resin may be 10:1 to 1.5:1. By using a hydroxyl acrylic resin and a non-hydroxyl acrylic resin at specific ratio, the adhesion of the coating layer formed from the coating composition is improved, and the quick-dry of the coating layer is further accelerated, thereby avoiding an interference between coating layers, such as, occurrence of lifting and performance degradation.

The first component may further comprise a pigment. The pigment may impart to the coating composition color and/or effect, and adjust the brightness and light transmittance of the coating layer formed from the coating composition. Suitable pigment for use in the present invention comprises carbon black, titanium white, red pigment, blue pigment, yellow pigment, pearl powder and/or aluminum powder, etc.

In general, the pigment may be added in the form of a color paste into the coating composition. For example, the pigment may be a color paste comprising carbon black. For example, the pigment may be a color paste comprising carbon black and titanium white.

Based on the total weight of the first component, the pigment may be present in the coating composition at about 0-30 wt. %.

The first component may further comprise a light unifiying aid. The light unifiying aid may adjust the divergence of light emitted by the coating, as observed with naked eyes from the other side of the coating (in the opposite side to light). Based on the total weight of the first component, the light unifiying aid may be present in the coating composition at about 0-5 wt. %.

The isocyanate curing agent contained in the second component may comprise monoisocyanate, diisocyanate and/or polyisocyanate. The “polyisocyanate” refers to a compound comprising three or more isocyanate (—NCO) groups. The isocyanate contained in the second component of the coating composition according to the present invention may comprise an aliphatic isocyanate and/or an alicyclic isocyanate.

The isocyanate may be made of monomers selected from: hexamethylene diisocyanate (HDI), isophorone diisocyanate (IPDI), and/or dicyclohexylmethane-4,4′-diisocyanate (HMDI). Suitably, the isocyanate curing agent may comprise an HDI-type isocyanate, i.e., an isocyanate made of monomers comprising HDI. In general, the second component may comprise 10 to 20 wt. % of an isocyanate curing agent, based on the total weight of the second component.

The second component may further comprise a diluent. The diluent may comprise, but is not limited to butyl acetate, Solvent Oil 100, xylene, PMA, or the like.

The coating composition according to the present invention may further comprise one or more other aids comprising, but not limited to, a substrate wetting agent which may improve the surface tension and the permeability of the coating composition, may wet the substrate better, and improve the adhesion of the coating; a defoaming agent which may inhibit the formation of foam in the coating composition; a dispersing agent which may promote the compatibility of ingredients in the coating composition; a levelling agent which may promote the levelling of the coating wet film; a UV-absorbing agent which may absorb UV light and improve the anti-aging property of the coating; an adhesion promoter which may increase the adhesion between the coating film and the substrate or the adhesion between the coating films; and the like. When these aids are present, each aid is present in an amount of at most about 2 wt. % based on the total weight of the coating composition. Suitably, the other aids may be present in the first component and/or the second component.

In the 2K coating composition of the present invention, the first component and the second component may have a weight ratio of 10:1 to 5:1.

The coating composition according to the present invention may be prepared by: (1) preparing a first component mixture of the coating composition; (2) preparing a second component mixture of the coating composition; and (3) mixing the first component mixture with the second component mixture.

In particular, the step (1) may be performed by mixing a hydroxyl acrylic resin, an optional non-hydroxyl acrylic resin, a solvent, optional aids, and an optional pigment at 10 to 35° C. and at a rotation speed of 500 to 1200 rpm; and then, stirring for 30-40 min.

The coating composition according to the present invention may be used to coat a substrate. The coated substrate comprises a substrate and the 2K coating composition coated on at least a part of the substrate. The substrate may comprise a plastic substrate, such as, polycarbonate (PC), poly(methyl methacrylate) (PMMA), and/or polypropylene (PP). The substrate may be transparent or translucent. Herein, the “transparent or translucent substrate” refers to a substrate which permits a certain proportion of visible light passing therethrough, and has a light transmittance of at least 2%. Suitably, the substrate may be a part of vehicles, e.g., light-emitting grille, bumper, trim, rearview mirror, and/or cover panel.

Suitably, the substrate may be treated or untreated. The substrate may or may not be pre-coated with a coating composition.

The 2K coating composition according to the present invention may be coated by means known to those skilled in the art, e.g., electrocoating, spraying, electrostatic spraying, dipping, rolling, brushing, etc., and then cured to form a coating layer. Suitably, the 2K coating composition according to the present invention may be baked at a temperature of about 60 to 100° C. for about 30 to 60 min for curing to form a dry film. The 2K coating composition according to the present invention may form a coating layer with a dry film thickness of 10 to 40 μm. The “dry film thickness” is a thickness of the coating layer of the coating composition after fully curing.

The present invention further relates to a coating system comprising a first coating composition and a second coating composition, wherein the first coating composition and/or the second coating composition are the above 2K coating composition.

Suitably, the coating layer formed from the first coating composition has a light transmittance of at least 90%. Suitably, the first coating composition is substantially free of pigment. Here, by “substantially free of” is meant that the content of the pigment in the coating composition is less than 1000 ppm based on the total weight of the coating composition. Suitably, the coating layer formed from the first coating composition may have a dry film thickness of 10 to 25 μm.

Suitably, a coating layer formed from the second coating composition has a light transmittance of less than 2%. Suitably, the second coating composition may comprise a pigment, such as, carbon black pigment, so that the second coating composition forms a coating with dark color. The dark color may be black or dark grey. Herein, by “dark color” is meant that the brightness value of the coating (the L value at 45-degree angle) is less than 60, based on the L*a*b color system specified in JIS Z 8729. Suitably, a coating layer formed from the second coating composition may have a L value at 45-degree angle of not greater than 30. Suitably, the coating layer formed from the second coating composition may have a dry film thickness of 20 to 35 μm. Herein, the light transmittance or L value of the coating layer is measured after applying the coating composition on a PC substrate and then curing.

The coating system according to the present invention may further comprise a third coating composition. Suitably, the coating layer formed from the third coating composition may have a light transmittance of less than 80%. For example, the coating layer formed from the third coating composition may have a light transmittance of 10-20%. For example, the coating layer formed from the third coating composition may have a light transmittance of 30-50%. Suitably, the third coating composition may comprise a pigment to impart to the coating a desirable color. Suitably, the coating layer formed from the third coating composition may have a dry film thickness of 20 to 35 μm.

Suitably, the third coating composition may be the above 2K coating composition.

In the coating system according to the present invention, the first coating composition may form a primer, the second coating composition may form a basecoat, and the third coating composition may form a topcoat. Suitably, the first coating composition and the second coating composition may be cured simultaneously. Herein, by “cured simultaneously” is meant that there is no curing step after the application of the first coating composition and before the application of the second coating composition, and the first coating composition and the second coating composition are cured in the same step.

The coating system according to the present invention may be used to coat a transparent or translucent plastic substrate, such as, PC, PMMA, and/or PP. Suitably, the substrate is a part of vehicles, comprising light-emitting grille, bumper, trim, rearview mirror, and/or cover panel. The coating system may meet the requirements of light transmittance effect, color effect and mechanical properties required by the transparent or translucent substrate.

In another aspect, the present invention further relates to a unit comprising an inner surface and an outer surface, wherein the inner surface is at least partially coated with a transparent primer, an opaque basecoat and a translucent topcoat, and the outer surface is at least partially coated with a transparent topcoat.

As stated above, by “transparent” coating is meant that the coating layer has a light transmittance of at least 90%. By “opaque” coating is meant that the coating layer has a light transmittance of less than 2%. By “translucent” coating is meant that the coating has a light transmittance of at least 2% and less than 90%.

Suitably, the coating layer of the opaque basecoat has an L value at 45-degree angle of less than 60, such as, an L value at 45-degree angle of not greater than 30, based on the L*a*b color system specified in JIS Z 8729.

Suitably, the translucent topcoat layer on the inner surface may have a light transmittance of 10-20%. Suitably, the translucent topcoat layer on the inner surface may have a light transmittance of 30-50%.

Suitably, the transparent primer layer on the inner surface has a dry film thickness of 10 to 25 μm. Suitably, the opaque basecoat layer on the inner surface has a dry film thickness of 20 to 40 μm. Suitably, the translucent topcoat layer on the inner surface has a dry film thickness of 20 to 40 μm. Suitably, the transparent topcoat layer on the outer surface has a dry film thickness of 10 to 20 μm.

Suitably, the transparent primer and/or the opaque basecoat for coating the unit may be the 2K coating composition according to the present invention.

The inner surface of the unit may comprise a light transmissive region. The light transmissive region may be covered by the transparent primer and/or the translucent topcoat. The light transmissive region may be formed by laser etching treatment, e.g., infrared laser etching treatment.

In the unit in accordance with the present invention, the inner surface faces a light source so that the light emitted from the light source passes through the light transmissive region of the inner surface, and finally emitted from the outer surface of the substrate. Thus, the unit in accordance with the present invention may achieve the desired light emitting and shading effects. At the same time, the unit in accordance with the present invention is laminated with a specific combination of coating layers, so that the substrate of the unit would meet the requirements of laser etching treatment, e.g., the substrate would not be damaged, lifting would not be occurred between coating layers on the substrate, and the various mechanical properties of the transparent/translucent substrate are improved.

The unit according to the present invention may be made of a transparent or translucent plastic substrate, such as, PC, PMMA, and/or PP. Suitably, the substrate is a part of vehicles, comprising light-emitting grille, bumper, trim, rearview mirror, and/or cover panel.

The present invention further relates to methods of treating a unit. By the treatment methods, the unit in accordance with the present invention as described above may be obtained.

The present invention provides a first method of treating a unit comprising: applying a transparent primer, an opaque basecoat and a translucent topcoat in sequence on at least a part of an inner surface of the unit; and applying a transparent topcoat on at least a part of an outer surface of the unit.

Suitably, the method further comprises:
after applying the opaque basecoat, treating part of the inner surface of the unit with laser etching. By laser etching, the transparent primer layer and/or the opaque basecoat layer on part of the inner surface may be removed.

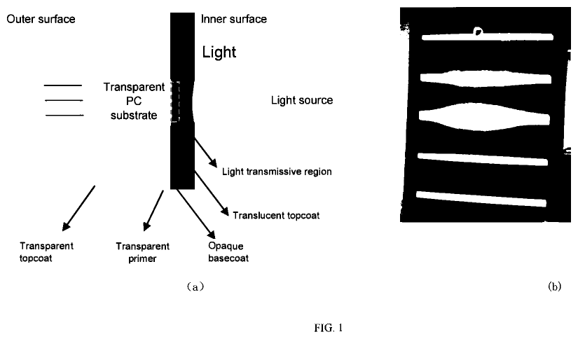

By the treatment method, the unit may achieve a desirable color effect and light transmittance. FIG. 1 shows a schematic view (a) and an illumination effect picture (b) of a substrate obtained in accordance with the treatment method of the present invention. At the same time, by the treatment method, various mechanical properties of the unit may be enhanced to meet the requirements for use. For example, the so-treated substrate may be a part of vehicles which meets various performance requirements of coatings for OEM.

The present invention additionally provides a second method of treating a unit comprising: applying a transparent primer, an opaque basecoat, a translucent basecoat and a transparent topcoat in sequence on an outer surface of the unit.

The method may further comprise:
after applying the opaque basecoat on the outer surface of the unit, treating part of the outer surface of the unit with laser etching. By laser etching, the transparent primer layer and/or the opaque basecoat layer on part of the outer surface may be removed.

Alternatively, the method may further comprise:
after applying the transparent topcoat on the outer surface of the unit, treating part of the outer surface of the unit with laser etching, and
optionally, after treating part of the outer surface of the unit with laser etching, applying a transparent topcoat on at least a part of the outer surface of the unit. By laser etching, the transparent primer layer, the opaque basecoat layer, the translucent basecoat layer and/or the transparent topcoat layer on part of the outer surface may be removed.

Alternatively, the method may further comprise:
applying a transparent primer and an opaque basecoat in sequence on at least a part of an inner surface of the unit, after applying the opaque basecoat on the inner surface of the unit, treating part of the inner surface of the unit with laser etching. By laser etching, the transparent primer layer and/or the opaque basecoat layer on part of the inner surface may be removed.

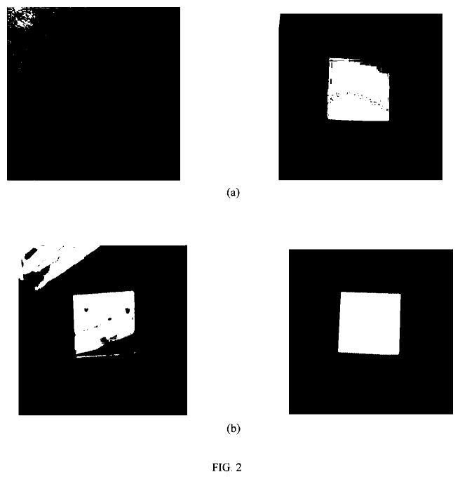

By the treatment method, the unit may achieve a desirable color effect and light transmittance. FIG. 2 shows an effect picture and an illumination effect picture of a unit obtained in accordance with the second treatment method of the present invention: (a) after applying the opaque basecoat on the outer surface of the unit, treating part of the outer surface of the unit with laser etching; and (b) after applying the transparent topcoat on the outer surface of the unit, treating part of the outer surface of the unit with laser etching.

The present invention additionally provides a third method of treating a unit comprising: applying a transparent primer and an opaque basecoat in sequence on at least a part of an inner surface of the unit; and applying a transparent primer, a translucent basecoat and a transparent topcoat on at least a part of an outer surface of the unit.

The method may further comprise:
after applying the opaque basecoat on the inner surface of the unit, treating part of the inner surface of the unit with laser etching. By laser etching, the transparent primer layer and/or the opaque basecoat layer on part of the inner surface may be removed.

The 2K coating composition according to the present invention may be adopted to the first, second and third methods of treating a unit. The 2K coating composition according to the present invention in combination with the three methods of treating a unit may provide a comprehensive effect of color, light transmittance, and mechanical properties. Suitably, in the three methods of treating a unit, the transparent primer and/or the opaque basecoat may be the 2K coating composition according to the present invention. Suitably, the translucent topcoat may be the 2K coating composition according to the present invention.

As stated above, by “transparent” coating is meant that the coating layer has a light transmittance of at least 90%. By “opaque” coating is meant that the coating layer has a light transmittance of less than 2%. By “translucent” coating is meant that the coating has a light transmittance of at least 2% and less than 90%.

In the three methods of treating a unit, the coating layer of the opaque basecoat has an L value at 45-degree angle of less than 60, such as, an L value at 45-degree angle of not greater than 30, based on the L*a*b color system specified in JIS Z 8729.

In the three methods of treating a unit, the coating layer of the transparent primer may have a dry film thickness of 10 to 25 μm. The coating of the opaque basecoat may have a dry film thickness of 20 to 40 μm. The coating layer of the translucent basecoat may have a dry film thickness of 20 to 40 μm. The coating layer of the translucent topcoat may have a dry film thickness of 20 to 40 μm. The coating layer of the transparent topcoat may have a dry film thickness of 10 to 20 μm.

### EXAMPLES

The following examples are provided to further illustrate the present invention, but they should not be considered as limiting the present invention to the details of the examples. Unless otherwise indicated, all the parts and percentages in the following examples are based on weight.

### Preparation of the 2K Coating Composition According to the Present Invention

The 2K coating compositions were prepared using the ingredients and amounts listed in Table 1 below. The preparation method comprised:
(1) mixing the ingredients listed in Table 1 at 10 to 35° C. in a stainless container at a rotation speed of 500 to 1200 rpm provided by a stainless stirrer, followed by stirring for 30-40 min to prepare the first component mixture of the coating composition; (2) mixing the HDI isocyanate curing agent and the diluent (butyl acetate and xylene) in a weight ratio of 68:32 to prepare the second component mixture of the coating composition; and (3) mixing the first component mixture and the second component mixture at a weight ratio of 10 to 5:1.

TABLE 1
The first component of the 2K Coating compositions according to the present
invention

| | Transparent | Transparent | Opaque | Opaque | Translucent | Translucent |
|---|---|---|---|---|---|---|
| | primer 1 | primer 2 | basecoat | basecoat | topcoat 1 | topcoat 2 |
| | (wt. %) | (wt. %) | 1 (wt. %) | 2 (wt. %) | (wt. %) | (wt. %) |
| Low-hydroxyl | 20 | 15 | 16 | 20 | 20 | 25 |
| acrylic resin ª | | | | | | |
| Medium- | 20 | 15 | 16 | 20 | 20 | 25 |
| hydroxyl acrylic | | | | | | |
| resin ^{b} | | | | | | |
| Non-hydroxyl | 10 | 20 | 8 | 0 | 10 | 0 |
| acrylic resin ^{c} | | | | | | |
| Ester solvent ^{d} | 35.8 | 35.8 | 20.8 | 20.8 | 33.8 | 33.8 |
| Alkane solvent ^{e} | 5 | 5 | 5 | 5 | 5 | 5 |
| Ketone solvent^{f} | 5 | 5 | 5 | 5 | 5 | 5 |
| Alcohol solvent | 1 | 1 | 1 | 1 | 1 | 1 |
| Levelling agent ^{h} | 0.2 | 0.2 | 0.2 | 0.2 | 0.2 | 0.2 |
| Adhesion | 2 | 2 | 2 | 2 | 2 | 2 |
| promoter ⁱ | | | | | | |
| UV absorbing | 1 | 1 | 1 | 1 | 1 | 1 |
| agent ^{j} | | | | | | |
| Black color | 0 | 0 | 25 | 25 | 1 | 1 |
| paste ^{k} | | | | | | |
| White color | 0 | 0 | 0 | 0 | 1 | 1 |
| paste ^{l} | | | | | | |

^{a} ZHP acrylic resin from DIC, in the form of solution with a solid content of about 55 to 65 wt. %, has a hydroxyl value of less than 30 mg KOH/g, a Mn of 10,000 to 30,000, an acid value of not greater than 15 mg KOH/g, and a Tg of not greater than 80° C.;
^{b} F acrylic resin from ELEMENTIS, in the form of solution with a solid content of about 45 to 55 wt. %, has a hydroxyl value of 30 to 70 mg KOH/g, a Mn of 10,000 to to 30,000, an acid value of not greater than 15 mg KOH/g, and a Tg of not greater than 80° C.;
^{c} B acrylic resin from DIC, in the form of solution with a solid content of about 25 to 30 wt. %, has a Mn of at least 40,000, and a Tg of not greater than 120° C.;
^{d} butyl acetate;
^{e} diisobutyl ketone;
^{f}cyclohexane;
^{g} n-butanol;
^{h} BYK 300 from BYK;
ⁱ TEGO ADDBOND LTW from EVONIK;
^{j} TINUVIN 400 from BASF;
^{k} PPG2792, including carbon black with a solid content of 35 to 55% in the paste;
^{l} PPG7819, including titanium white with a solid content of 65 to 85% in the paste.

The compositions of the transparent primers 1-2, the opaque basecoats 1-2 and the translucent topcoats 1-2 were applied on a PC substrate, respectively, and then baked at 60-100° C. for 30-60 min. After that, the substrates comprising coating layers formed from the coating compositions were tested as follows.

### 1—Adhesion to the Substrate

The “adhesion” refers an adhesive capacity of the coating to the substrate surface and the cohesive capability of the coating itself. Herein, the adhesion of the coating was measured in accordance with GB/T 9286 standard.

6×6 scribed lines were made with a NT knife on the sample surface (25 squares of 1 mm², and the scribed lines should be deep to the substrate). The test surface was maintained as flat as possible (keep the cutting edge of the knife sharp). If the sample is too small to provide sufficient space for gridding, the grids was scribed in a 45-degree direction. A Nichiban adhesive tape (No. 405), a Scotch adhesive tape (No. 610) or other adhesive tapes of the same type (18 mm wide, and the adhesiveness of the tape should be greater than or equal to 5.3 N/18 mm wide) was adhered to the sample surface, and compressed with an eraser to make the tape fully contact with the test surface. The sample stood for 3 minutes, and then the adhesive tape was quickly peeled out in a 90-degree direction. The test surface was visually examined, and rated by reference to the ISO standard.

Rating in accordance with the ISO standard:
Rating 0: 5B.
Completely smooth edge of cut, with no peeling at the edge of grid.
Rating 1: 4B.
Small piece of peeling at the intersection of cuts, with actual damage of less than or equal to 5% in the grid area.
Rating 2: 3B.
Peeling at the edge or intersection of cuts, with the damaged area of greater than 5% to 15%.
Rating 3: 2B.
Partial peeling or a large piece of peeling along the edge of cut, or some whole grids of peeling, with the peeled area of greater than 15% to 35%.
Rating 4: 1B.
Large peeling at the edge of cut, or partial or all peeling of some grides with the peeled area of greater than 35% to 65%.
Rating 5: 0B.
Pieces of coating peeling at the edge and intersection of the scribed lines with the total peeled area of greater than 65%.

As tested, each of the transparent primers 1-2, the opaque basecoats 1-2 and the translucent topcoats 1-2 presented an adhesion of 5B to the PC substrate.

### The Coating System/Unit According to the Present Invention

A PC substrate was coated with the transparent primer 1, the opaque basecoat 1 and the translucent topcoat 1 to give the unit 1; and a PC substrate was coated with the transparent primer 2, the opaque basecoat 2 and the translucent topcoat 2 to give the unit

2. The method specially comprises:
pre-treating (i.e., washing and drying) the surface of the PC substrate to clean the substrate;
coating the surface A of the substrate with the transparent primer and the opaque basecoat in sequence, followed by curing;
treating part of the surface A of the substrate with infrared laser etching;
coating the surface A of the substrate with the translucent topcoat, followed by curing; and
coating the surface B (the opposite surface to the surface A) of the substrate with a transparent topcoat, followed by curing.

Of those, the transparent topcoat on the surface B is a commercially available transparent topcoat of UV5000 from Momentive which can be used for OEM coatings. The units 1 and 2 were respectively tested as follows:

### 1—Adhesion to the Substrate

The “adhesion” refers an adhesive capacity of the coating to the substrate surface and the cohesive capability of the coating itself. Herein, the adhesion of the coating was measured in accordance with GB/T 9286 standard.

6×6 scribed lines were made with a NT knife on the sample surface (25 squares of 1 mm², and the scribed lines should be deep to the substrate). The test surface was maintained as flat as possible (keep the cutting edge of the knife sharp). If the sample is too small to provide sufficient space for gridding, the grids was scribed in a 45-degree direction. A Nichiban adhesive tape (No. 405), a Scotch adhesive tape (No. 610) or other adhesive tapes of the same type (18 mm wide, and the adhesiveness of the tape should be greater than or equal to 5.3 N/18 mm wide) was adhered to the sample surface, and compressed with an eraser to make the tape fully contact with the test surface. The sample stood for 3 minutes, and the adhesive tape was quickly peeled out in a 90-degree direction. The test surface was visually examined, and rated by reference to the ISO standard.

Rating in accordance with the ISO standard:
Rating 0: 5B
Completely smooth edge of cut, with no peeling at the edge of grid.
Rating 1: 4B
Small piece of peeling at the intersection of cuts, with actual damage of less than or equal to 5% in the grid area.
Rating 2: 3B.
Peeling at the edge or intersection of cuts, with the damaged area of greater than 5% to 15%.
Rating 3: 2B.
Partial peeling or a large piece of peeling along the edge of cut, or some whole grids of peeling, with the peeled area of greater than 15% to 35%.
Rating 4: 1B.
Large peeling at the edge of cut, or partial or all peeling of some grides with the peeled area of greater than 35% to 65%.
Rating 5: 0B. Pieces of coating peeling at the edge and intersection of the scribed lines with the total peeled area of greater than 65%.

### 2—Moisture Resistance

The “moisture resistance” refers to an ability to keep the coating performance constant in a humid environment. In the text, the moisture resistance of the coating was measured in accordance with the steps of:
keeping the coating to stand at 95+5% RH for 240 hours, and then evaluating the adhesion and appearance of the coating. The measurement method and the rating standard of the coating was as stated above.

Appearance: the coating layer was not peeled off of the substrate, and there was no visual or touch changes such as expansion, softening, stickiness, or brightening.

Substrate adhesion: There was no damage in the coating under a load of 10N in accordance with the rating standard.

### 3—Aging Resistance

The “aging resistance” refers to the ability of the coating to resist adverse effects such as light, humidity, high temperature, or the like in use and keep its original performance. In the text, the aging resistance of the coating was measured by the steps of: keeping the coating to stand at 70° C. for about 7 days, followed by evaluating the appearance and the substrate adhesion of the coating.

If the coating can simultaneously meet the following requirements, it is deemed to have an aging resistance.

Appearance: the coating layer was not peeled off of the substrate, and there was no visual or touch changes such as expansion, softening, stickiness, or brightening.

Substrate adhesion: the adhesion achieved at least 4B in accordance with the rating standard.

### 4—Humidity Freeze Cycle

The humidity freeze cycle resistance of the coating was tested in accordance with GMW14797. The testing method comprised: allowing the unit to undergo the following cycle 15 times:
20 h @ 38° C., ˜100% RH+3 h @−30° C.+1 h @ RT;
followed by evaluating the appearance and the substrate adhesion of the coating.

If the coating can simultaneously meet the following requirements, it is deemed to have a humid freeze resistance.
Appearance: the coating layer was not peeled off of the substrate, and there was no visual or touch changes such as expansion, softening, stickiness, or brightening;
Substrate adhesion: the adhesion achieved at least 4B in accordance with the rating standard.

### 5—Light Transmissive Effect

As shown in FIGS. 1 and 2, the units in accordance with the present invention had desired color and light transmissive effect.

The results of the performance tests are summarized as follows:

| Performance test | Unit 1 | Unit 2 |
|---|---|---|
| Adhesion | Rating 0 | Rating 0 |
| Moisture resistance | OK | OK |
| Aging resistance | OK | OK |
| Humidity freeze cycle | OK | OK |

1. A two-component (2K) coating composition, comprising a first component and a second component, wherein the first component comprises a hydroxyl acrylic resin and an organic solvent, and the second component comprises an isocyanate curing agent,
wherein the hydroxyl acrylic resin has a number average molecular weight of 10,000 to 30,000, the hydroxyl acrylic resin comprises an acrylic resin with a low hydroxyl value and an acrylic resin with a medium hydroxyl value, wherein the acrylic resin with a low hydroxyl value has a hydroxyl value of less than 30 mg KOH/g, and the acrylic resin with a medium hydroxyl value has a hydroxyl value of 30 to 70 mg KOH/g.

2. The 2K coating composition of claim 1, wherein the first component further comprises a non-hydroxyl acrylic resin.

3. (canceled)

4. (canceled)

5. The 2K coating composition of claim 1, wherein the hydroxyl acrylic resin has an acid number of not greater than 15 mg KOH/g.

6. (canceled)

7. (canceled)

8. The 2K coating composition of claim 2, wherein the non-hydroxyl acrylic resin has a number average molecular weight of at least 40,000.

9. The 2K coating composition of claim 2, wherein the weight ratio of the hydroxyl acrylic resin to the non-hydroxyl acrylic resin is 10 to 1.5:1.

10. The 2K coating composition of claim 1, wherein the organic solvent comprises an ester solvent, a ketone solvent, an alkane solvent, an alcohol solvent, or a combination thereof.

11-16. (canceled)

17. The 2K coating composition of claim 1, further comprising a pigment.

18. A coated substrate comprising a substrate and the 2K coating composition of claim 1 applied on at least a part of the substrate.

19. The coated substrate of claim 18, wherein the substrate comprises PC, PMMA, and/or PP.

20. The coated substrate of claim 18, wherein the substrate is transparent or translucent.

21. The coated substrate of claim 18, wherein the substrate is a part of a vehicle.

22. The coated substrate of claim 18, wherein a coating layer formed from the 2K coating composition has a dry film thickness of 10 to 40 μm.

23. A coating system, comprising a first coating composition and a second coating composition, wherein the first coating composition and/or the second coating composition are a two-component (2K) coating composition,
comprising a first component and a second component, wherein the first component comprises a hydroxyl acrylic resin and an organic solvent, and the second component comprises an isocyanate curing agent, wherein the hydroxyl acrylic resin has a number average molecular weight of 10,000 to 30,000, the hydroxyl acrylic resin comprises an acrylic resin with a low hydroxyl value and an acrylic resin with a medium hydroxyl value, wherein the acrylic resin with a low hydroxyl value has a hydroxyl value of less than 30 mg KOH/g, and the acrylic resin with a medium hydroxyl value has a hydroxyl value of 30 to 70 mg KOH/g.

24. The coating system of claim 23, wherein a coating layer formed from the first coating composition has a light transmittance of at least 90%.

25. The coating system of claim 23, wherein a coating layer formed from the second coating composition has a light transmittance of less than 2%.

26. The coating system of claim 23, wherein a coating layer formed from the second coating composition has an L value at 45-degree angle of less than 60.

27. (canceled)

28. The coating system of claim 23, further comprising a third coating composition, wherein a coating layer formed from the third coating composition has a light transmittance of less than 80%.

29. The coating system of claim 28, wherein the third coating composition is a 2K coating composition comprising a first component and a second component, wherein the first component comprises a hydroxyl acrylic resin and an organic solvent, and the second component comprises an isocyanate curing agent, wherein the hydroxyl acrylic resin has a number average molecular weight of 10,000 to 30,000, the hydroxyl acrylic resin comprises an acrylic resin with a low hydroxyl value and an acrylic resin with a medium hydroxyl value, wherein the acrylic resin with a low hydroxyl value has a hydroxyl value of less than 30 mg KOH/g, and the acrylic resin with a medium hydroxyl value has a hydroxyl value of 30 to 70 mg KOH/g.

30-54. (canceled)
